(19) United States
(12) Patent Application Publication
(10) Pub. No.: US 2009/0294373 A1
(43) Pub. Date: Dec. 3, 2009

(54) INHIBITION OF WATER FORMED SCALE IN ACID CONDITIONS

(76) Inventors: Jasbir S. Gill, Naperville, IL (US); Daniel N.T. Hay, Naperville, IL (US)

Correspondence Address: William J. Maheras;Patent and Licensing Department, Nalco Company, 1601 West Diehl Road, Naperville, IL, 60563-1198, US

(21) Appl. No.: 12/371,674

(22) Filed: Feb. 16, 2009

Related U.S. Application Data
(63) Continuation-in-part of application No. 12/130,515, filed on May 30, 2008.

(51) Int. Cl. C02F 5/02; C02F 5/04; C02F 5/14; C02F 101/00

(52) U.S. Cl. 210/697; 210/696; 210/699; 210/701

(57) ABSTRACT

The current invention relates to the inhibition of scale deposits in a slurry or solution under acidic conditions. The current invention uses an aqueous synthetic mixture comprising a phosphate, phosphonate, anionic polymer, or combinations thereof in the slurry and/or solution to inhibit scale deposition from acidic process streams. The control of scale under acidic conditions is difficult because the acidic environment renders most known inhibitors ineffective. The claimed invention causes a significant decrease in the scale generated allowing for reduced down time of systems for de-scaling procedures and thus increasing production.

### CROSS REFERENCE TO RELATED APPLICATIONS

This application is a continuation in part to U.S. patent application Ser. No. 12/130,515, which was filed on May 30, 2008, from which filing priority is hereby claimed and the disclosure of which is hereby incorporated by reference.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to the inhibition of deposit (fouling) containing scales such as calcium sulfate, barium sulfate, calcium fluoride, calcium fluosilicate, etc. from acidic aqueous solutions by addition of synthetic aqueous mixtures containing organic phosphonates, organic phosphate derivatives, inorganic phosphates, anionic polymers and copolymers, or a combination thereof.

### BACKGROUND

The processing of various types of ore and other materials including biological must sometimes be conducted in an acidic environment to produce the end product. In wet process phosphoric acid production a crude ore that has been upgraded or beneficiated by washing, desliming, flotation, and then grinding is digested in an acidic solution. After digestion is completed the resulting slurry is subjected to a filtration step followed by evaporation of the acid stream and subsequent clarification steps to produce a finished product, which then can be added to other products. In another application, the process stream from a slaughterhouse is ground and digested with an acidic solution to produce fats and proteins for animal feed and other applications. In yet another process, the capture of sulfur dioxide from base metal smelters produces calcium sulfate as a by-product in an acidic environment due to sulfuric acid production.

One of the most bothersome problems associated with the acidic processing of ores and other materials is the formation of scale deposits. The scale formation occurs primarily in the digesters, evaporators and equipment associated therewith. A certain amount also occurs on other surfaces of the process including the filtration systems. Particularly troublesome is scaling of heat exchanger surfaces. Most attempts to correct this problem have been directed to equipment design but even the best-designed equipment is not capable of preventing scale formation. Scale formation is most troublesome when acidic conditions exist; typically the acidic environment renders most known scale inhibitors ineffective.

Due to the high concentrations of calcium sulfate produced by the processing of phosphate ore, animal waste including bones, etc., or in base metal smelters, these are ideal processes for the use of the claimed invention. Calcium sulfate is the primary ingredient of scales caused from the digestion of phosphate ore, the processing of animal remains, or in base metal smelting. There are different crystallographic forms of calcium sulfate responsible for scale deposition. These forms, Gypsum (CaSO₄.2H₂O), calcium sulfate Hemihydrate (CaSO₄.½H₂O), and calcium sulfate Anhydrite (CaSO₄) are dependent on temperature and the residence time within the process. This phase transformation adds to the complexity of their inhibition. Additional important ingredients of these scales can be fluosilicate salts, barium sulfate, calcium fluoride, and/or other materials depending on the composition of the process stream and specific process conditions. It is the prevention of these mixed scales that makes it is possible to inhibit and substantially prevent scale formation occasioned in the production of phosphoric acid or other processes.

The present invention is predicated upon the discovery that certain water-soluble organic and inorganic phosphates, phosphonates, polycarboxylates and their homopolymers or copolymers, and their mixtures are able to inhibit both formation and adherence of deposit causing minerals from acidic solutions.

The current invention is a method of preventing formation and adherence of scale/deposit causing minerals on surfaces in contact with acidic solutions using a scale inhibiting compound or their formulations at substoichiometric amounts. The preferred application point is in the acid stream directly prior to it entering the evaporator(s) and while in the evaporator(s) or any other unit operation where precipitation and deposition/scale formation typically occurs. Inhibitors are typically added within a dosage range of 0.1-5000 ppm, preferably 0.1-100 ppm and most preferably 0.1-50 ppm.

As an example, the wet process production of phosphoric acid generally involves the digestion of a phosphate containing ore slurry with sulfuric acid. The resulting phosphoric acid is separated from precipitated calcium sulfate and other solid impurities by filtration. The phosphoric acid solution is then concentrated through evaporation and clarified to yield the finished phosphoric acid (˜50-70% P₂O₅). Although much of the calcium sulfate and other impurities are removed during the filtration step, a significant amount remains dissolved in the acidic process stream after filtration. As the phosphoric acid is concentrated through the evaporator circuit, calcium sulfate of various forms continues to precipitate from solution resulting in scale deposition on high temperature surfaces due to the inverse relationship between calcium sulfate(s) solubility and temperature. This and other deposits negatively impact heat transfer to the process stream as well as restrict liquor flow. Consequently, the scale must be removed through periodic cleanouts. Thus, the scaling phenomenon causes significant loss of process efficiency and results in added cost.

The manufacture of phosphates and phosphoric acid is further detailed in the work by Becker, “Phosphates and Phosphoric Acid,” copyright 1989 by Marcel Dekker, Inc. and Slack, “Phosphoric Acid, Part I and Part II,” copyright 1968 by Marcel Dekker, Inc.

The addition of scale inhibitors to acidic aqueous simulated process solutions resulted in the reduction of deposited scale by up to 95-97% compared to an equivalent untreated solution.

### Inorganic Phosphate:

Is comprised of a compound containing the phosphate moiety or phosphate units linked by phosphoanhydride bonds.

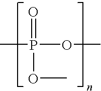

where n≧1

### Organic Phosphate:

Comprised of an ester of inorganic phosphate.

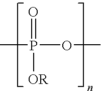

where R is alkyl or aryl and n≧1

### Phosphonate:

Comprised of a compound containing the structural moiety.

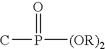

where R is H, alkyl, or aryl

### Polycarboxylate:

Comprised of a polymer derived from monomers containing the carboxylic acid functional group or salts thereof selected, for example, from the group consisting of acrylic acid, methacrylic acid, α-haloacrylic acid, maleic acid or anhydride, vinylacetic acid, allylacetic acid, fumaric acid, and β-carboxyethylacrylate. Polycarboxylate copolymers can also incorporate, along with carboxy containing monomers, monomers containing the sulfonic acid group or salts thereof selected, for example, from the group consisting of 2-acrylamido-2-methylpropylsulfonic acid, 2-methaerylamido-2-methylpropylsulfonic acid, vinylsulfonic acid, sulfoalkyl acrylate, sulfoalkyl methacrylate, allylsulfonic acid, methallylsulfonic acid, and 3-methacrylamido-2-hydroxypropylsulfonic acid.

### Homopolymer:

Comprised of a polymer derived from only one monomeric species.

### Copolymer:

Comprised of a polymer derived from two or more monomeric species (heteropolymer).

### SUMMARY

The current invention describes the following key aspects:
1. It is an advantage of the invention to provide the reduction of scale build up in acid conditions.
2. It is an advantage of the invention to inhibit scale formation within various sections of the process in which it is used, thus allowing for flexibility of use.
3. It is an advantage of the invention to provide increased operating time between required cleanouts.
4. It is an advantage of the invention to provide a method for uninterrupted production.
5. It is an advantage of the invention to increase throughput.

### DETAILED DESCRIPTION

The claimed invention is a process for inhibiting both the formation and adherence of scale/deposit causing minerals under acid conditions wherein an ore or other material is combined with a solution in a digestion process to react forming a slurry, which is passed through a purification process to form a stream where a scale inhibiting composition is added at any point from digestion onward in the production process. The process has the flexibility that the scale inhibiting composition can be additionally added prior to or during digestion and/or to the slurry and/or prior to the processing of the slurry and is added in substoichiometric amounts. Other material(s) can include the process stream from a slaughterhouse, the by-product of base metal smelting, or industrial acid washes. The claimed invention applies to any processes where mineral scale is formed in an acidic environment and must be inhibited.

The claimed invention allows digestion to occur in digesters or over heat exchangers and the purification process can be either or both filtration and settling of solids. The current invention is useful in any process that has an acidic environment and can inhibit the formation of mineral scale or eliminate the adherence of the mineral scale to another surface.

The preferred scale inhibiting composition contains a phosphorous component and is added to the slurry from 0.1 to 5000 ppm and preferably at 0.1 to 100 ppm and most preferably at 0.1 to 50 ppm. The scale inhibiting composition may be one or a combination of an organic phosphate, a phosphonate, an inorganic phosphate, a polycarboxylate homopolymer or copolymer.

The current invention additionally relates to a process for inhibiting the formation and adherence of scale/deposit causing minerals in an acid production wherein an ore is combined with a solution for digestion and forms a slurry where a scale inhibiting composition can be added to the slurry prior to the solid/liquid separation process. The scale inhibiting composition can be additionally added prior to or during digestion, or at any point from digestion onward in the production process. The ore can be beneficiated prior to being combined with the solution. The solution can be acidic such as sulfuric acid. The scale inhibiting composition can be one or a combination of an organic phosphate, a phosphonate, an inorganic phosphate, a polycarboxylate homopolymer or copolymer.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims

We claim:

1. A process for inhibiting both the formation and adherence of scale/deposit causing minerals under acid conditions wherein an ore or other material is combined with a solution in a digestion process to react forming a slurry which is passed through a purification process to form a stream wherein a scale inhibiting composition is added at any point from digestion onward in the production processes.

2. The process of claim 1 wherein the scale inhibiting composition is additionally added prior to or during digestion.

3. The process of claim 1 wherein the scale inhibiting composition is additionally added to the slurry.

4. The process of claim 1 wherein the digestion process occurs in digesters or over heat exchangers.

5. The process of claim 1 wherein the purification process is filtration and/or settling of solids.

6. The process of claim 1 wherein the production process includes an evaporation process wherein the scale inhibiting composition is added to the stream during said evaporation process.

7. The process of claim 6 wherein the scale inhibiting composition is added to the stream prior to entering the evaporation process.

8. The process of claim 1 wherein the scale inhibiting composition is added prior to or during any stage in the process in which scale-causing minerals from acidic solutions are formed.

9. The process of claim 1 wherein the solution is an acid.

10. The process of claim 1 where the scale inhibiting composition is one or a combination of an organic phosphate, a phosphonate, an inorganic phosphate, a polycarboxylate homopolymer or copolymer.

11. The process of claim 1 where the scale inhibiting composition is added in substoichiometric amounts.

12. The process of claim 1 where the scale inhibiting composition is added from 0.1 to 5000 ppm.

13. The process of claim 1 where the scale inhibiting composition is added from 0.1 to 100 ppm.

14. The process of claim 1 where the scale inhibiting composition is added from 0.1 to 50 ppm.

15. The process of claim 1 where the other material is a process stream from a slaughterhouse, the by-product of base metal smelting, or industrial acid washes.

16. A process for inhibiting both the formation and adherence of scale/deposit causing minerals under acid conditions wherein an ore is combined with a solution in a digestion process to react forming a slurry which is passed through a solid/liquid separation process to form a stream where a scale inhibiting composition is added at any point from digestion onward in the production processes.

17. The process of claim 16 wherein the scale inhibiting composition is added prior to or during digestion.

18. The process of claim 16 wherein the ore is beneficiated prior to being combined with the solution.

19. The process of claim 16 wherein the solution is acidic.

20. The process of claim 16 where the scale inhibiting composition is one or a combination of an organic phosphate, a phosphonate, an inorganic phosphate, a polycarboxylate homopolymer or copolymer.

21. The process of claim 16 wherein the scale inhibiting composition is added prior to or during any stage in the process in which scale-causing minerals from acidic solutions are formed.
